(19) United States
(12) Patent Application Publication
(10) Pub. No.: US 2003/0042858 A1
(43) Pub. Date: Mar. 6, 2003

(54) Motor driver circuit to operate in limited power environment

(76) Inventor: Richard L. Weinbrenner, Lemont, IL (US)

Correspondence Address: Jeffrey P. Calfa, 954 Rice Court, Naperville, IL, 60565, US

(21) Appl. No.: 10/226,535

(22) Filed: Aug. 23, 2002

Related U.S. Application Data
(60) Provisional application No. 60/314,469, filed on Aug. 23, 2001.

(51) Int. Cl. H02P 1/00; H02P 3/00

(52) U.S. Cl. 318/139

(57) ABSTRACT

The invention provides a method for limiting the power rate requirement by electronically advantaging the torque or force of a motor. The method is comprised of a local electrical energy storage reservoir, a function to charge the energy reservoir at a controllable rate, and a power controlled motor driver, and an energy management motion controller. This is an electrical circuit, which achieves a similar ‘speed verses force’ tradeoff as a mechanical reduction transmission. The circuit may be used to move cellular antenna repositioning motors where the motive power source may be less than the continuous rating of the repositioning motor.

This is a non-provisional patent application claiming the priority of provisional patent application Serial No. 60/314,469, filed Aug. 23, 2001.

### BACKGROUND OF THE INVENTION

This invention relates to positioning motors where the motor will not have a tendency to back drive or drift while the power is off. In such applications, power may be applied to the motor in bursts that would exceed the power available from the power supplying the motor if required on a continuous basis. This application has applicability especially where motors are located in remote locations. In these situations, power transfer per unit distance may be a higher cost. One such application is providing power and control of motors for repositioning cellular phone antennas on towers.,

In many applications this invention:

allows use of a smaller less expensive motor to perform the application

permits selection of a smaller gauge wire for remotely powered motors over long cables

limits maximum power draw from the power supply by electronically extending the positioning time

Generally this engineering tradeoff is exercised by using a mechanical transmission e.g. Gearbox, that is to provide a mechanical reduction transmission which will divisibly scale the output shaft rotation rate but multiply the shaft torque by the transmission ratio.

With a given mechanical transmission and a given motor, this invention provides an additional electronically scalable speed verses torque tradeoff similar to that achieved by the mechanical transmission or gearing.

### OBJECT OF THE INVENTION

One general object of the invention is to provide an alternate system of achieving a speed versus torque tradeoff that can be used in place of or in conjunction with a mechanical transmission. A second general object of the invention is to provide a method of power rate verses time of motion tradeoff. An ancillary objective is to provide circuit to drive a motor with a power source rated below the motor's standard rating. This objective being useful for operating a remote motor such as that on the top of a cellular antenna tower for adjusting aspects of a cellular smart antenna system.

The motor driver circuit of this invention achieves the above objectives as well as others not mentioned. The motor driver circuit of this invention includes a power source connected to charge a power storage component. The output of the power source and the power storage component may be electrically connected to a motor. A processor controls the rate of charge and discharge of the power storage device as well as the passage of power from the power source on an intermittent basis. The processor's intermittent control allows the motor to receive energy from the power source and from the power storage device simultaneously. As such the power source may be rated below the suggested continuous power requirement of the specific motor.

As way of example, consider that 5 pounds of force is required of an electric motor linear motion actuator using a lead screw to translate the mechanical rotation to mechanical linear travel and the required travel is executed within 15 seconds and require 6 watts. Consider a second case, where the same total energy is used if the 5 pounds of force is applied for 30 seconds. However in the second example, the rate of power required is cut in half to 3 watts. An electrical measure of power rate is the watt. A system that accomplishes its task in the example above and takes the longer time will require a power supply of lower wattage.

### BRIEF DESCRIPTION OF THE DRAWINGS

FIG. 1 is a functional block diagram of the elements of an embodiment of the invention.

FIG. 2 is a simplified buck converter configured to regulate the charge current of the energy storage element and therefore the input power.

FIG. 3 a simplified boost-converter to provide the higher desired motor driver voltage.

FIG. 4 is a logic diagram for a programming example for the processor of FIG. 1.

FIG. 5 is a cellular phone tower with a motor drive circuit made in accordance with this invention installed.

### DETAILED DESCRIPTION

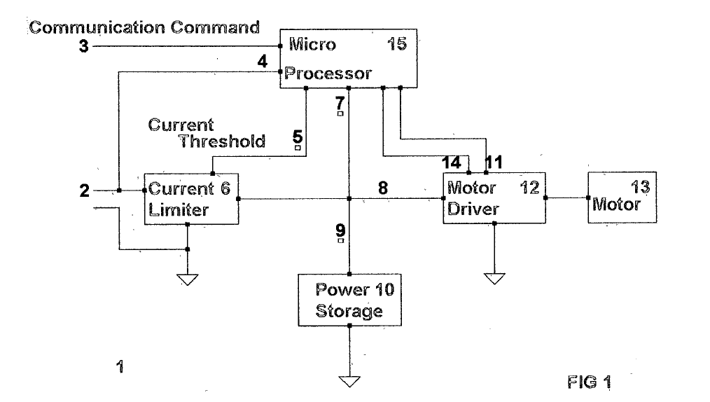

The motor driver circuit 1 of this invention includes a power source 2 connected to charge a power storage component 10. The output of the power source 2 and the power storage component 10 may be electrically connected to a motor 13. A processor 15 controls the rate of charge and discharge of the power storage device 10 as well as the passage of power from the power source 2 on an intermittent basis. The processor's 15 intermittent control allows the motor 13 to receive energy from the power source 2 and from the power storage device 10 simultaneously. As such the power source 2 may be rated below the suggested continuous power requirement of the specific motor 13. See FIG. 1.

Power is used at a limited rate by the motor 13 from the power source or supply 2. For example if the input power is limited to 2 watts, then this invention will manage the motor drive system to never exceed that power draw limit.

The motor driver circuit 1 consists of an input power limiting stage and an output motor driving stage.

The input stage is comprised of current limiter 6 and power or energy storage component 10 and its associated elements. The energy storage component 10 may be a battery, a capacitor, including a super capacitor. The control goal of this input stage is to draw no more than the specified limited power level from power source input 2. The voltage of power source 2 may be higher or lower than the voltage at which the energy is stored in the storage component 10 when the embodiment of this invention employs switching power conversion technique.

The output stage consists of motor commutation function 12 and storage component 10. The voltage at which the energy is stored in the power storage component 10 may be higher or lower than the voltage delivered to the motor 13 when the embodiment of this invention employs switching power conversion technique.

The circuit input power limit goal is ‘embedded in’ or ‘communicated to’ the processor which may be referred to as an energy management microprocessor or DSP 15, using communication path 3.

The motor circuit 1 may be viewed as performing multiple processes. In the energy charging processes, the energy management processor 15 includes an analog to digital converter, which permits it to measure the input power supply voltage 2. The microprocessor program asserts control 5 to current limiter 6 such that the design current limit value is established. This controlled current level will result in the commanded power supply current or wattage load when computed in conjunction with the measured supply voltage. The commanded current is made available to power bus 8 and it begins to charge Energy Storage element 10 via path 9. As current is supplied the voltage of bus 8 rises. The energy management microprocessor or DSP 15, via analog input 7 monitors the voltage of the Energy Storage element 10. Once the energy stored in 10 reaches its limit as indicated by the maximum voltage allowed for the circuit, microprocessor 15 turns off current limiter 6 via its control output 5. This constant power input limited energy storage process is operating continuously, and if the voltage on bus 8 drops below a chosen threshold the process will again begin to operate to recharge the energy storage device 10 but never exceeding the stated input power load goal.

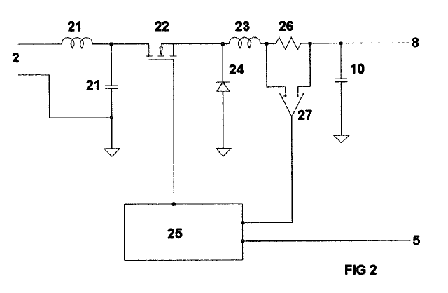

One simplified embodiment of a switching current limiter is illustrated in FIG. 2. A transistor switch 22 is modulated using a PWM pulse width modulation waveform to its control gate. When switch 22 is ‘ON’, energy flows from the power supply input 2 through EMI filter 21, the switch 22 and inductor 23 into Energy Storage capacitor 10 and current sensing resistor 26. The current passing through sensor 26 is amplified by 27 and monitored by current regulation control-block 25 and compared against the current limit command 5, which was asserted from the energy management microprocessor 15. By this means the current regulation control block can build the desired energy storage level in the storage capacitor 10 while not exceeding the design current draw limit. Other limiting circuits may be used including inefficient linear current limiting circuits or components.

Another of the processes of the motor driver circuit 1 is the motor driver process. In the motor driver process, the energy management microprocessor 15 may employ several different algorithms to accomplish the function of this invention. These are described here as mode 1 and mode 2. Although there is a continuum between the functionality of mode 1 and mode 2, the differences in the algorithm performance and behavior are described for the two cases where the energy storage element 10 is small or where the energy storage element 10 is large.

In mode 1, a small electrolytic capacitor is employed as the power storage element 10. The motor 13 is run a small distance at its full rated current, then de-powered. It is important that the mechanical aspects of the motor 13 to not back drive the motor rotor during the time it is de-powered. The motor 13 needs to have a capacitance to sustain the small rotor displacement for a short period. In the case where the motor is driven with a constant current motor drive the required capacitance is calculated with the equation below.

$$C = \frac{I \cdot t}{V}$$

Where I is full motor drive power current, t is time motor drive time, and V is design accepted voltage drop in C.

The charging function will charge the energy storage 10 element quickly due to its small size. This mode can appear to run the motor 13 continuously or in slightly more course steps. The distance to drive the motor 13 between power off periods may be optimized to match the motor magnetic detent period. For example if the motor is a step motor, every 4 full steps is a natural power off magnetic detent torque position, where the motor rotor is stable during the power off period. In such a system the powered off period may be just a few ten's of milliseconds.

In mode 2, the energy storage device 10 may be a very large capacitance in the multi-Farad range. As soon as power is applied to the system, the capacitor 10 begins to charge.

However in this case enough energy is accumulated to drive the motor 13 for a few seconds or tens of seconds, depending on the electrical size of the capacitor and the draw of the motor 13. In this case the input current is limited and when the motor command is received the entire positioning may be done at full speed.

If this energy requirement is less than the energy available in Energy Storage 10, then the move can be initiated at 100 percent duty cycle. An optimization of this algorithm will take into consideration the power available via path 2. For example if the motor required 4 watts and the power limit parameter in force is 1 watt, then the algorithm may draw at a rate of 3 watts from energy storage 10 and 1 watt from supplied power source 2.

If the power required completing the motion exceeds the power stored in storage device 10 plus that available from power source 2, then the motion may be segmented. Such a move will be short of the commanded position, then the charging process is permitted to recharge energy storage device 10 to a point where the control algorithm can complete the move or accomplish the next segment of the move.

In many applications moves may be short of full travel, and in such applications this system will complete the move as quickly as a system, which was not, power limited. An advantage over a gearing system is that this system can be charged prior to receiving the positioning command, whereas the gear system obtains its torque speed tradeoff only during the move.

The aforementioned segmented-move (mode 2) may be aesthetically unpleasing in some applications. An improvement in such applications will be achieved by advancing the motor 13 by its natural electrical pole cycle. This is a very short usage of power which will discharge energy storage only a little but will drive motor 13 at its full rating and therefore achieving its full torque for a short move. Then the motor will be de-energized or switched to a low holding torque power level, awaiting some recharge of energy storage 10 via current limiter 6. Based on a computed time and duty cycle first algorithm or on the energy threshold second algorithm the motor will be run through the next pole cycle sequence or possibly multiple pole sequences. A 15-degree step motor, for example has a 4 pole cycle characteristic between natural power off detents. This operational strategy causes the motor to appear to be moving continuously, while limiting the average power (mode 1).

The processor 15 may control the motor 13 and a motor power-supply 12 via enable control signal 11 and commutate signal 14.

One example of a current limiter 6 of FIG. 1 is shown in FIG. 2. It would be possible to use a linear current regulator to fulfill this function it would result in great inefficiencies. Several switching power supply topologies already known in the art circuits can be adapted to this purpose.

For a system that would ‘step up’ the voltage to the storage element 10 a boost, fly-back or forward converter topology could be used.

FIG. 2 depicts a simplified buck converter configured as a current rather than the more typical voltage regulator for charging the energy storage element 10 to its full capacity. Furthermore energy storage element 10 may be specified as a very high farad capacitor, sometimes referred to as Super Capacitors. High value capacitors can provide an advantage over chemistry based batteries as they will operate over a wider temperature range, and can be charged and discharged rapidly and many times. The maximum voltage tolerance of such components is typically 2-5 volts at this time, although technology advancement may change this.

The power source 2 if filtered by the inductor and capacitor circuit 21 to reduce EMI electromagnetic interference as is good engineering practice.

The circuit depicted by FIG. 2 regulates the current charging the energy storage element 10 by switching between two states at high frequency, such as 20-over 100 kHz.

Switch S1 typically an electronic transistor is closed by the control circuit 25 and current begins to rise through inductor 23 and flows into the multi-farad capacitor energy storage element 10 and through the low ohm current sensing resistor 24. Control circuit 25 monitors the charge current via amplifier 27 by sensing the I*R drop and when it reaches the current limit computed by the control circuit and delivered via input 5 the control circuit turns off switch 22. Then the energy stored in inductor 23 continues to flow into storage element 10 through current sensing resistor 24, and via the common ground connection to diode 24 to complete the circuit for the inductor 23 discharge. This process continues until the charge voltage of capacitor 10 indicates it is full at which time this charge circuit is shutdown by microprocessor 15 via control signal 5.

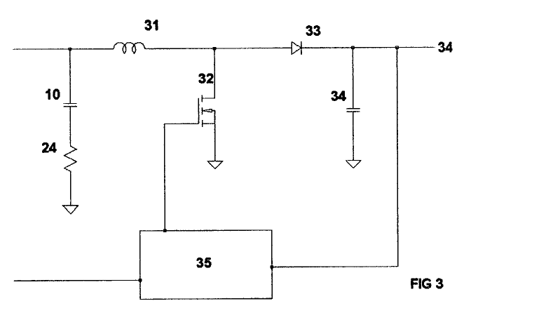

FIG. 3 depicts a power conversion stage known in the art as a boost converter topology circuit to accept the low voltage of storage element 10 in this embodiment, and if necessary, raises the voltage to a level more suitable for the motor driver circuit 1.

This converter uses the energy storage element 10 as its input power. Switch 32 is closed and builds energy in boost inductor 31. After the on period of the switchmode cycle, switch 32 is opened and the energy in the inductor flows through diode 33 and builds voltage in the capacitor 34. The voltage is monitored by boost switchmode control circuit 35 and as voltage 34 raises to the threshold specified by controller 35 input 11.

The block 12 from FIG. 1 may include both a motor driver or commutation stage in addition to the power, conversion stage depicted in FIG. 3. Various types of motors can be used with this invention including but not limited to BLDC, stepper, induction, and brush DC motors. In fact any motor with an appropriate drive method can be used.

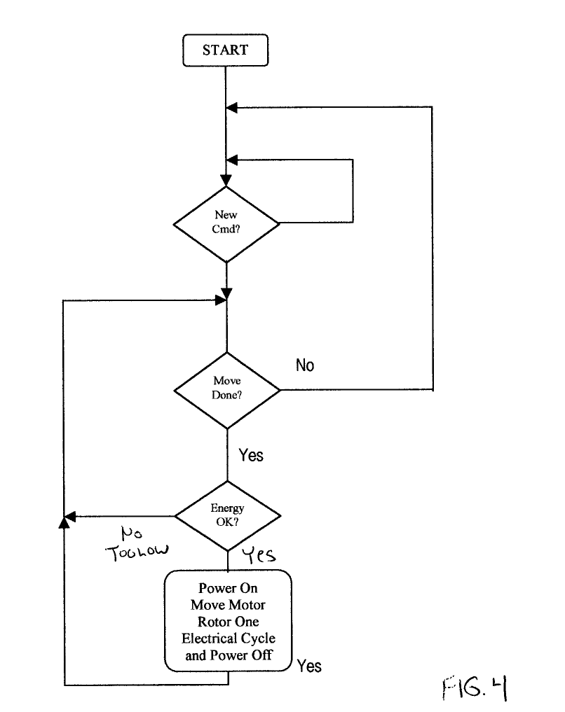

The processor 15 may be programmed as shown in FIG. 4 to implement mode 1 control. The processor initially checks whether it has a new command such as a move command. If no, it waits to check for commands. If yes to the query of whether there is a new command, the processor 15, checks if the last move is completed, if yes, then the processor continues to check for new commands. If the last ordered move is not completed, the processor checks if the power storage component 10 has sufficient power to supplement the power source 2 to move the motor 13. If there is not sufficient energy, the processor waits and allows further charging of the power storage component 10, subsequently checking if the move is complete. If the power storage component 10 has sufficient energy to supplement the power source for the next electrical cycle of the motor 13 on the last ordered move, the processor applies the power of the power source 2 and the energy storage device 10 to the motor 13. This moves the motor 13 one electrical cycle and then the processor 15 turns ‘OFF’ the power from the combination of the power source 2 and the energy storage device 10 and subsequently checks if the ordered move is complete.

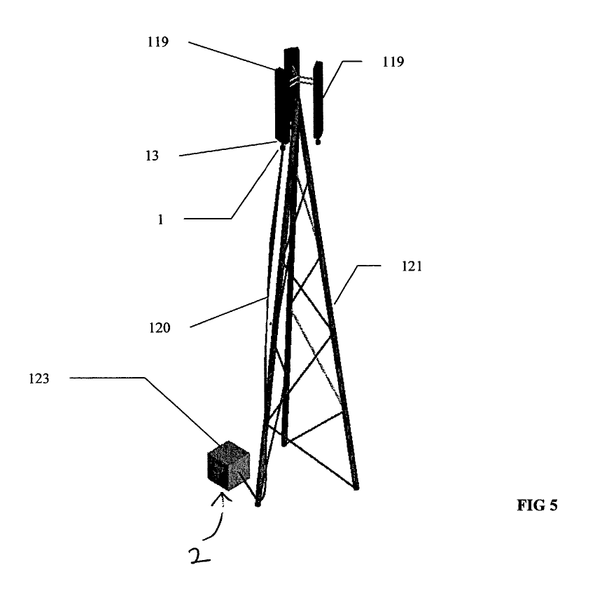

One useful application for the motor driver circuit is to drive motors located a distance from a power source. One example would be motors for repositioning apparatus of smart cellular phone antennas. An example is shown in FIG. 5. These motors 13 are necessarily located at or near the top of antenna towers 121 and are for repositioning antenna appartus 119. The motor driver circuit 1 of this invention can be used to drive such antenna 119 repositioning motors 13 with the power source 2 below that which the repositioning motors 13 are rated and reduce the required cable sizes and voltage drops incurred in such applications. In the example shown the power source 2 is on the ground and connected to the driver circuit 1 via cabling 120 with the power source receiving external supply 123. The driver circuit 1 could have also been on the ground level with the motor 13 in the tower 121.

As described above, the motor driver circuit 1 and motor driver circuit in combination with an antenna apparatus 119 repositioning motor 13 provides a number of advantages, some of which have been described above and others of which are inherent in the invention. Also modifications may be proposed to the motor driver circuit 1 and motor driver circuit 1 in combination with an antenna apparatus 119 repositioning motor 13 without departing from the teachings herein.

I claim:

1. A motor driver circuit for driving a motor, the motor having a continuous duty rating, comprising:
a power source in communication to charge an energy storage component and to provide power to drive the motor;
an output of said power source and said energy storage component electrically connected to an output to the motor;
a processor engaged to said power source and said energy storage component to control a rate of charge and discharge of said storage component and passage of energy from said power source on an intermittent basis;
said processor's intermittent control allowing said output to the motor to receive energy from said power source and from said energy storage component simultaneously; and
said power source rated below the continuous duty rating of the motor.

2. The motor driver circuit of claim 1, wherein: said processor programming comprised of the following steps:
checking whether a new move command exists;
where no new move command exists, waiting to check again for new moves after a designated time period;
where a new move command exists, checking if a last ordered move is completed;
where a last move is completed, waiting to check again for new moves after a designated time period;
where a last ordered move is not completed, said processor checking if said energy storage component has sufficient power to supplement said power source to move the motor;
where there is not sufficient energy, said processor waiting a designated period to allow charging of said energy storage component, subsequently checking if the last ordered move is complete; and
where said processor finds said power storage component has sufficient energy to supplement said power source for the next electrical cycle of the motor on the last ordered move, said processor applying the power of said power source and said energy storage component to the motor, moving the motor one electrical cycle and then said processor turns ‘OFF’ the power from said power source and said energy storage component and subsequently checks if the last ordered move is complete.

3. A motor driver circuit for driving a motor, comprising:
an input power limiting stage and an output motor driving stage;
said input stage including a current limiter and an energy storage component;
said input stage limiting no more than a specified limited power level from a power source input;
said output stage engaged to said input stage and having a motor commutation function driveable by said power source input and said energy storage component;
said circuit input power limit being controlled from a micro-processor electrically engaged to said current limiter;
said processor including an analog to digital converter permitting said processor to measure input power supply voltage;
said processor program controlling said current limiter to establish a commanded design current limit value;
commanded current being engageable through control from said processor to charge said energy storage component;
said processor monitoring voltage increases as a result said storage component's charging;
said processor programmed to turn off said current limiter once energy stored in said storage component reaches a limit as indicated by the maximum voltage allowed;
said processor continuing to monitor for decreases in storage element charge, and if monitored voltage drops below a chosen threshold, said processor programmed to recharge said storage component without exceeding an input power load goal.

4. The motor driver circuit of claim 3, wherein:
said energy storage component is a capacitor.

5. The motor driver circuit of claim 3, wherein:
said energy storage component is a battery.

6. A motor driver circuit for driving a motor, comprising:
an input power limiting stage and an output motor driving stage;
said input stage including a current limiter and an energy storage component;
said input stage limiting no more than a specified limited power level from a power source input;
said output stage engaged to said input stage and having a motor driver function driveable by said power source input and said energy storage component;
a microprocessor engaged to said input stage to control said power source and said energy storage component to drive a motor;
a small capacitor being said energy storage component;
said motor having a capacitance to sustain small rotor displacement for short periods for short durations; and
said capacitance set at a value approximating a product of full motor drive power current and a time of motor drive, divided by design accepted voltage drop.

7. A motor driver circuit for driving a motor, comprising:
an input power limiting stage and an output motor driving stage;
said input stage including a current limiter and an energy storage component;
said input stage limiting no more than a specified limited power level from a power source input;
said output stage engaged to said input stage and having a motor driver function driveable by said power source input and said energy storage component;
a microprocessor engaged to said input stage to control said power source and said energy storage component to drive a motor; and
a large capacitor being said energy storage component, said capacitor capacity allowing rated motor speed upon processor application of said power source input and said energy storage component to a motor.

8. A motor driver circuit in combination with a motor driven antenna apparatus, comprising:
a power source in communication to charge an energy storage component and to provide power to drive a motor;
said motor engaged to reposition an antenna apparatus;
an output of said power source and said energy storage component electrically connected to an output to said motor;
a processor engaged to said power source and said energy storage component to control a rate of charge and discharge of said storage component and passage of energy from said power source on an intermittent basis;
said processor's intermittent control allowing said output to the motor to receive energy from said power source and from said energy storage component simultaneously; and
said power source rated below a continuous duty rating of said motor.

9. The motor driver circuit of claim 8, wherein:
said processor programming comprised of the following steps:
checking whether a new move command exists;
where no new move command exists, waiting to check again for new moves after a designated time period;
where a new move command exists, checking if a last ordered move is completed;
where a last move is completed, waiting to check again for new moves after a designated time period;
where a last ordered move is not completed, said processor checking if said energy storage component has sufficient power to supplement said power source to move the motor;
where there is not sufficient energy, said processor waiting a designated period to allow charging of said energy storage component, subsequently checking if the last ordered move is complete; and
where said processor finds said power storage component has sufficient energy to supplement said power source for the next electrical cycle of said motor on the last ordered move, said processor applying the power of said power source and said energy storage component to the motor, moving said motor one electrical cycle and then said processor turning ‘OFF’ power from said power source and said energy storage component and subsequently checks if the last ordered move is complete.

10. The motor driver circuit and antenna apparatus combination of claim 9, wherein:
said energy storage component is a capacitor.

11. The motor driver circuit and antenna apparatus combination of claim 9, wherein:
said energy storage component is a battery.

12. A motor driver circuit in combination with a motor driven antenna apparatus, comprising:
an input power limiting stage and an output motor driving stage;
said input stage including a current limiter and an energy storage component;
said input stage limiting no more than a specified limited power level from a power source input;
said output stage engaged to said input stage and having a motor driver function driveable by said power source input and said energy storage component;
a microprocessor engaged to said input stage to control said power source and said energy storage component to drive said motor;
said motor engaged to reposition an antenna apparatus; a small capacitor being said energy storage component;
said motor having a capacitance to sustain small rotor displacement for short periods for short durations; and
said capacitance set at a value approximating a product of full motor drive power current and a time of motor drive, divided by design accepted voltage drop.

13. The motor driver circuit and antenna apparatus combination of claim 12, wherein:
said energy storage component is a capacitor.

14. A motor driver circuit in combination with a motor driven antenna apparatus, comprising:
an input power limiting stage and an output motor driving stage;
said input stage including a current limiter and an energy storage component;
said input stage limiting no more than a specified limited power level from a power source input;
said output stage engaged to said input stage and having a motor driver function driveable by said power source input and said energy storage component;
a microprocessor engaged to said input stage to control said power source and said energy storage component to drive a motor;
said motor engaged to reposition an antenna apparatus; and
a large capacitor being said energy storage component, said capacitor capacity allowing rated motor speed upon processor application of said power source input and said energy storage component to a motor.

15. The motor driver circuit and antenna apparatus combination of claim 14, wherein: said energy storage component is a capacitor.
